(19) United States
(12) Patent Application Publication
(10) Pub. No.: US 2012/0280474 A1
(43) Pub. Date: Nov. 8, 2012

(54) TRANSPORTATION DEVICE

(76) Inventor: Patrick Murphy, East Feluga QLD (AU)

(21) Appl. No.: 13/511,294

(22) PCT Filed: Nov. 22, 2010
(86) PCT No.: PCT/AU2010/001566

§ 371 Date: Jul. 25, 2012

(30) Foreign Application Priority Data
Nov. 23, 2009 (AU) 2009905737

(51) Int. Cl. B62B 1/12

(52) U.S. Cl. 280/659

(57) ABSTRACT

A transportation device includes a frame and a support member for supporting one or more objects placed thereon. The support member is movable relative to the frame. The support member is arranged such that, in an unloaded condition, the support member is positioned towards an upper end of the frame. Placing an item or load on the support member causes the support member to move to a lower position.

### FIELD OF THE INVENTION

The present invention relates to a transportation device. In particular, the present invention relates to a transportation device (such as a hand truck) which largely reduces or eliminates the bending required by a user when loading or unloading the transportation device.

### BACKGROUND ART

Typically, hand trucks are used in order to move objects (such as relatively small packages, parcels or the like) from place to place. For instance, hand trucks are often used for the delivery of objects that may be too heavy, bulky or numerous to carry by hand.

Conventional hand trucks include a shelf located at ground level and onto which a first object is placed. Further objects are typically stacked on the first object. When loading and unloading a conventional hand truck, a user is required to bend or squat down to place the first object on the shelf at ground level. This is an awkward movement for a user and, if the object is particularly heavy or bulky, it could lead to a user injuring themselves through bending or through incorrect lifting practices. In addition, if a user is moving a large number of objects (for instance, if the user is a courier or delivery person), the repetitive bending and lifting action may cause strain or injury over a period of time.

Thus, there would be an advantage if it were possible to provide a hand truck with reduced or eliminated the need for a user to bend or squat in order to place objects onto (or remove objects from) a hand truck.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

It is an object of the present invention to provide a transportation device which may overcome at least some of the abovementioned disadvantages, or provide a useful or commercial choice.

In one aspect, the present invention provides a transportation device comprising a frame, support means for supporting one or more objects placed thereon, the support means being movable relative to the frame, wherein the support means is arranged such that, in an unloaded condition, the support means is positioned towards an upper end of the frame, and whereupon placing an item or load on the support means causes the support means to move to a lower position.

Suitably, the support means is arranged such that placing an item or load on the support means causes the support means to move to a first lower position and placing a further item or load on the support means causes the support means to move to a second lower position, the second lower position being located below the first lower position, and so on.

Desirably, the support means is arranged such that the first lower position is located below the unloaded position by, a distance approximately equal to a height of an item placed on the support means. In this manner, placing an item of the support means causes the support means to move to the first lower position. In this position, the top of the item that has been placed on the support means is now positioned roughly where the support means would sit in the unloaded condition. When another item is placed on the transportation device, it may be conveniently and easily placed on top of the first item because the top of the first item is located at a convenient height.

In some embodiments, the transportation device further includes a transmission assembly associated with the support means, the transmission assembly being adapted to control movement of the support means. In some embodiments, the transmission assembly may include one or more extendable and retractable struts. The one or more extendable and retractable struts may comprise one or more gas struts.

In a preferred embodiment, the transportation device may be provided with one or more support guides adapted to ensure the smooth and correct movement of the support means between the various positions. Any suitable support guides may be used, such as one or more tracks, rails or the like with which at least a portion of the support means is associated. In this embodiment of the invention, the support means may suitably be provided with one or more support guide location means (for instance, one or more projections or the like) which are adapted to ensure that the support means is correctly located in relation to the support guides, and that the support means remains correctly located in relation to the guide means as the support means moves between the various position.

Desirably, the transportation device of the present invention does not require a power source for its operation. Instead, it is preferred that the transportation device reacts passively in that the transportation device is actuated solely in response to a load being placed on (or removed from) the support means. In this embodiment of the invention, the mass of the items being added to or removed from the support means alone is sufficient to actuate the movement of the support means.

Accordingly, in another aspect the invention resides broadly in a transportation device comprising a frame, support means for supporting one or more objects placed thereon, the support means being movable relative to the frame, and a transmission assembly associated with the support means such that the transmission assembly is adapted to control the movement of the support means, and wherein the transmission assembly includes at least one biasing means.

The frame may be of any suitable size or configuration. Preferably, however, the frame comprises at least one frame member. The at least one frame member may be of any suitable construction, for instance the at least one frame member may be a single member of any suitable width against which the one or more objects may abut during use of the transportation device.

Alternatively, the frame may comprise a plurality of frame members. In this embodiment, the frame may comprise two or more substantially vertical frame members. In a preferred embodiment of the invention, the two or more substantially vertical frame members may be interconnected (for aesthetic purposes, bracing or strengthening purposes, or both) with one or more cross frame members. The cross frame members may be disposed at any suitable angle to the vertical provided that the cross frame members interconnect at least two of the two or more substantially vertical frame members.

A skilled addressee will understand that the exact construction of the frame is not critical, and that the frame could be constructed in a number of ways and be suitable for use in the present invention.

Preferably, the transportation device is provided with transporting means. The transporting means may be of any suitable type, such as, but not limited to, one or more wheels, slides, skids, endless tracks, casters, rollers or the like, or any combination thereof. In a preferred embodiment of the invention, the transporting means are located in a lower region of the frame such that the transporting means are in contact with the ground during use of the transportation device. If desired, the transporting means may be associated with control means, such as brakes, a drive mechanism (such as a motor), or the like, or a combination thereof. Alternatively, the control means may be actuated manually (such as by a user pushing or pulling the transportation device).

In a preferred embodiment of the invention, the frame may be provided with one or more handling means to assist a user with the handling of the transportation device. The handling means may be of any suitable type, however in a preferred embodiment, the handling means may be in the form of one or more hand holds, including handles, hand grips or the like, or a combination thereof. Preferably, the handling means are provided in an upper portion of the frame, although a skilled addressee will understand that handling means may be placed in more than one location on the frame to assist with handling of the transportation device under a variety of different conditions, and may be used by users having different heights and so on.

The support means may be of any suitable size, shape or configuration. Preferably, however, the support means is of sufficient size and strength to adequately support one or more objects that are to be plated thereon.

Thus, in a preferred embodiment of the invention, the support means comprises at least a platform onto which the one or more objects may be placed. Alternatively, the platform may be, provided with one or more raised portions (e.g. lips) at edges thereof in order to prevent the one or more objects from sliding or falling off the platform. In further embodiments of the invention, the platform may include one or more side walls that define a receptacle into which at least one of the one or more objects may be placed.

Preferably the support means extends substantially horizontally outwardly from the frame, such that the support means provides a substantially horizontal platform onto which the objects may be placed. In some embodiments of the invention, the support means may be adapted to contract, hinge or fold against the frame, for instance to reduce the bulkiness of the transportation device during storage. Any suitable mechanism may be used to cause the support means to contract or fold, such as providing the support means as a telescoping platform, or by providing the support means with hinges to allow the support means to be folded against the frame.

As previously stated, the support means is movable relative to the frame. Preferably, the support means is movable between an unloaded condition and a fully loaded condition. Ina preferred embodiment of the invention, the support means may also be movable between one or more partially loaded conditions intermediate the unloaded condition and the fully loaded condition. In this embodiment of the invention; the condition to which the support means moves is preferably determined by the mass of the one or more objects placed thereon. Preferably, a predetermined mass of the objects will be required to move the support means between the various conditions. For instance, if no objects are placed on the support means, the support means will be located in the unloaded condition. If a first particular mass of objects are placed on the support means, the support means may move to a first partially loaded condition. Similarly, a second particular mass of objects placed on the support means (or on top of the, first particular mass of objects), the support means may move to a second partially loaded condition, and soon. The masses required to move the support means between the various conditions may be the same or may be different to one another.

In an alternative embodiment of the invention, no particular mass of objects may be required to move the support means between partially loaded conditions. In this embodiment, placing a first mass of objects on the support means may cause the support means to move a certain distance between the unloaded and the fully loaded conditions, while a second mass of objects may cause the support means to move a further distance between the unloaded and the fully loaded conditions. Thus, the support means may be movable between one or more partially loaded conditions, but the partially loaded conditions are not set at predetermined locations between the unloaded condition and the fully loaded condition.

In further embodiments of the invention, the support means may be adapted to remain fixed in a particular position. For instance, if desired, the support means may be fixed in the fully loaded position regardless of the load placed on the support means. Thus, the transportation device may be capable of being converted to a conventional hand truck.

In a preferred embodiment, the frame may be provided with a lower support. Preferably, the lower support is fixed, such that as the support means approaches the fully loaded condition, the support means abuts the lower support, thus preventing any unwanted further movement and providing additional support for the fully loaded support means. The lower support may be of any suitable form, such as a shelf, platform, land, one or more protrusions or the like.

The transmission assembly may be of any suitable type. The transmission assembly suitably includes at least one biasing means. Any suitable biasing means (or load resisting means) may be used, such as, but not limited to, an extendable and retractable ram or strut (such as a pneumatic or hydraulic strut), a spring or the like, or any suitable combination thereof. Preferably, when the support means is in its unloaded condition, the biasing means is fully extended. In a preferred embodiment of the invention, when the support means is in the unloaded condition, it is located adjacent an upper portion of the frame. In this way, a first object (or first plurality of objects) may be placed on the support means without requiring the user to bend or squat to placed the objects on the support means.

The mass of the objects may overcome at least some of the resistance provided by the at least one biasing means. If this resistance is overcome, the biasing means may at least partially retract, thereby enabling the support means to move at least part way between the unloaded condition and the fully loaded condition. Further objects may be stacked on the support means until the resistance of the biasing means is entirely overcome (i.e. the biasing means retracts fully) and the support means moves to the fully loaded condition. In a preferred embodiment of the invention, when the support means is in the fully loaded condition, the support means is located adjacent a lower portion of the frame and, preferably, at or adjacent ground level.

In this way, each time objects are stacked on the support means, the point at which new objects may be stacked will be located at or adjacent an upper portion of the frame, such that the need to bend or squat to place objects on the support means is minimised or eliminated.

Similarly, when objects at the top of the stack of objects on the support means are removed, the biasing means may extend partially, thereby causing the support means to move upwardly from the fully loaded condition towards the unloaded condition. As further objects are removed, the support means will continue to move towards the unloaded condition until reaching the unloaded condition when all objects have been removed.

Thus, each time stacked objects are removed from the support means, the uppermost objects will be located at or adjacent an upper portion of the frame, such that the need to bend or squat to remove objects from the support means is minimised or eliminated.

In some embodiments one biasing means may be present. However, in other embodiments of the invention, a plurality of biasing means may be present. Preferably, the one or more biasing means are mounted within the frame. The biasing means may be located substantially vertically, or may be disposed at an angle intermediate the vertical and the horizontal position relative to the frame. In some embodiments of the invention, at least one biasing means may be located in each orientation.

In other embodiments of the invention, a first group of one or more biasing means may be located in a first position within the frame, while a second group of one or more biasing means may be located in a second position within the frame. Preferably, the first and second positions are located at different points along the height of the frame. In this embodiment, the first group and second group of biasing means may act as independent modules, such that the resistance of the first group of biasing means must be overcome before the second group of biasing means may be actuated.

In an alternative embodiment of the invention, the biasing means may be fully retracted when the support means is in the unloaded condition. Then, as objects are placed on the support means, the biasing means may at least partially extend such that the support means moves at least partially between the unloaded condition and the fully loaded condition. Similarly, as objects are removed from the supports means, the biasing means may at least partially retract between the fully loaded condition and the unloaded condition.

The one or more biasing means may be of any suitable variety, and a skilled addressee will understand that the exact type of biasing means used is not critical. For instance, in some embodiments of the invention, it is envisaged that gas struts, telescoping gas struts, or variable pressure struts, or a combination thereof, may be used.

In some embodiments, the transmission assembly may further include one or more drive means adapted to complement the action of the one or more biasing means. For instance, if the mass of objects on the support means is insufficient to cause actuation of the biasing means (thereby moving the support means either towards the fully loaded condition or towards the unloaded condition), the one or more drive means may be used to assist in creating the desired movement. The one or more drive means may be manually actuated (for instance, by making use of a manual momentary switch, or by manually actuating the one or more drive means) or automatically actuated (for instance, on receipt of a signal from one or more sensing means, wherein the sensing means may include one or more load sensors, proximity sensors or the like, or a combination thereof). Alternatively, the one or more drive means may be capable of both manual and automatic actuation.

While any suitable drive means could be used, in a preferred embodiment of the invention, the drive means comprises one or more motors. Preferably, the one or more motors are electric motors, although it is envisaged that any suitable type of motor could be used. In embodiments of the invention in which electric motors are used, the one or more motors may be powered using any suitable power source, such as one or more batteries, one or more solar cells, mains power, or the like, or any combination thereof.

Preferably, the one or more motors are powered using one or more batteries. Any suitable type, voltage and size of battery may be used. It is envisaged that, for instance, as the support means moves between the unloaded and the fully loaded conditions (or vice versa), the action of the biasing means will largely be sufficient to control the movement of the support means. Thus, it is envisaged that the movement of the support means between the unloaded and the fully loaded conditions may be used to generate an electrical current which may be stored in the one or more batteries. Thus, if the one or motors are required to assist the movement of the support means from the fully loaded condition to the unloaded condition (or vice versa), the electrical current drawn from the one or more batteries may be relatively low. In this way, the operational life of the one or more batteries may be extended.

It is envisaged that, should the one or more batteries deplete during use of the transportation device, it may be possible to at least partially charge the one or more batteries by causing movement of the support means between the unloaded and fully loaded conditions (or vice versa). By doing this, it may be possible to provide the one or more batteries with sufficient charge to ensure that the one or more motors may continue to operate without fully recharging (for instance, by connecting the one or more batteries to mains power, a generator or the like) or replacing the one or more batteries.

Preferably, the transmission assembly further includes one or more transmission members. In a preferred embodiment of the invention, the movement of support means in reaction to the retraction or extension of the one or more gas struts may be actuated by the one or more transmission members. In some embodiments, the one or more transmission members may be adapted at one part thereof for connection to the support means, while at another part thereof the one or more transmission members may be adapted for connection to the one or more biasing means. In this way, the retraction or extension of the one or more biasing means causes movement of the one or more transmission members, which thereby causes movement of the support means.

The one or more transmission members may be of any suitable form. However, in a preferred embodiment of the invention, the one or more transmission members may comprise one or more elongate members. Preferably, the one or more elongate members may be relatively inextensible. Thus, in a preferred embodiment of the invention, the one or more transmission members may comprise chains, cables (for instance, metal or polymer cables), ropes, or the like, or any combination thereof. In this embodiment, the one or more transmission members may be connected to the support means at a first end thereof, and to the one or more biasing means at a second end thereof.

In some embodiments, the one or more transmission members may be connected directly between the support Means and the one or more biasing means. Alternatively, the first end of the transmission member may be connected to a transmission support, the transmission support being in direct or indirect communication with the one or more biasing means. For instance, the transmission support may comprise a flange, platform or the like in direct or indirect communication with the one or more biasing means and to which the transmission member is attached. Retraction or extension of the one or more biasing means may cause movement of the transmission support which, in turn, causes the transmission member to actuate the support means.

The transmission support may be adapted to move within the frame. Alternatively, the transmission assembly may be provided with one or more support guides (e.g. rails, tracks or the like) associated with the transmission support and in with the transmission support moves.

In a further embodiment of the invention, the transmission assembly may include one or more guide means (such as pulleys, blocks, rollers, bearings, sprockets, lubricated moving parts or the like) with which the one or more transmission members may be associated. In a preferred embodiment of the invention, the transmission assembly comprises a pair of guide means per transmission member, although a skilled addressee will understand that alternative embodiments could be used. For instance, a first guide means may be located in an upper portion of the frame, while a second guide means may be located in a lower portion of the frame. The one or more transmission members may be threaded through, or otherwise passed around the guide means such that there is little or no slack in the one or more transmission members.

In an alternative embodiment, the transmission assembly may include gearing means. For instance, the gearing means may include a rack and pinion arrangement that may be used as a winch, a sprocket and chains arrangement and the like. In some embodiments of the invention, the transmission assembly may include both guide means and gearing means. For instance, in embodiments of the invention in which the guide means are fixed to the frame, gearing means may be used to provide a ratio differentiation between the amount of travel in the support means compared to the amount of travel of the one or more biasing means.

Alternatively, one or more of the guide means may be adapted for connection to the transmission support, such that a movement of the transmission support results in a movement of the guide means (and therefore the transmission member), thereby causing a movement in the support means.

The transmission assembly is preferably located within an area defined by the placement of the frame members such that the transportation device of the present invention is not substantially different in overall size to a conventional hand truck or the like. In some embodiments of the invention, the frame may be provided with one or more enclosure members adapted to ensure that the transmission assembly is at least partially enclosed within the frame. The purpose of the one or more enclosure members may be to improve the aesthetics of the transportation device, to reduce the risk of damage to the transmission assembly, to prevent a user's clothing or body becoming trapped in the transmission assembly, or a combination thereof.

In a most preferred embodiment of the invention, the transportation device comprises a hand truck, trolley or the like.

It is envisaged that the one or more objects may include any suitable object, such as packages, parcels, boxes, crates, irregularly-shaped items, documents, clothing, or the like, or any combination thereof. Preferably, although not necessarily, the one or more objects may be stacked upon each other so as to make their transportation easier. However, a skilled addressee will understand that the objects need not be stackable, and there need not be multiple objects present in order to use the transportation device of the present invention.

In another aspect the invention resides broadly in a hand truck comprising a frame, support means for supporting one or more objects placed thereon, at least one elongate transmission member mounted at one end thereof to the support means and at least one biasing means, wherein the addition or removal of a load to the support means results in the movement of the support means relative to the frame, and wherein the degree of movement of the support means is controlled by the at least one biasing means.

A skilled addressee will understand that the present invention provides a number of significant advantages. For instance, the present invention reduces or eliminates the need for a user to bend in order to place or remove objects on or from the transportation device. In addition, the present invention eliminates the need for batteries, mechanical winches or pumps to create hydraulic lift forces. Further, the transportation device of the present invention reduces the amount of energy required to operate due to the fact that energy may be stored in the biasing means. Finally, the transportation device of the present invention has the advantage that the biasing means may be adjusted to a higher or lower resistance, or the transmission ratios on the gearing means may be adjusted, so that the transportation device may be used for objects having varied sizes or weights.

### BRIEF DESCRIPTION OF THE DRAWINGS

An embodiment of the invention will be described with reference to the following drawings in which:

FIGS. 1A-1C illustrate schematic views of a transportation device according to an embodiment of the present invention;

FIGS. 2A-2C illustrate partial views of a transmission assembly according to one embodiment of the present invention;

FIGS. 3A-3C illustrate side elevation views of a transportation device according to another embodiment of the present invention; and

FIG. 4 illustrates a side sectional view of a transportation device according to yet another embodiment of the present invention.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

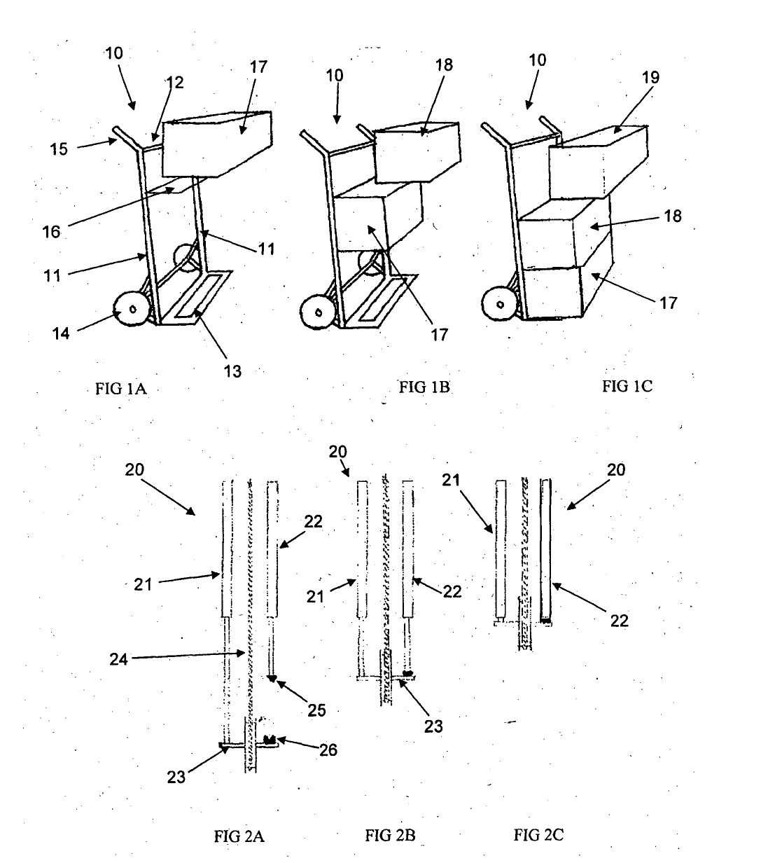

In FIG. 1A there is shown a schematic view of a transportation device 10 according to an embodiment of the present invention. The transportation device 10 is a hand truck comprises a frame including a pair of vertical frame members 11, a horizontal frame member 12 and a lower support 13 in the form of a shelf or platform. The hand truck 10 is provided with a pair of wheels 14 at the lower end of the vertical frame members 11 to facilitate easy movement of the hand truck 10.

An upper end of each of the vertical frame members 11 is positioned at an angle to the lower portion of the vertical frame members 11 so as to form a pair of handles 15.

The hand truck 10 is provided with support means 16 in the form of a platform. In FIG. 1A the platform 16 is in the unloaded condition, meaning that the platform is located an upper portion of the hand truck 10. In FIG. 1A a first object 17 is loaded onto the platform 16. The weight of the first object 17 overcomes the resistance of one or more biasing means (not shown), thereby causing the platform 16 to move from the unloaded condition shown in FIG. 1A to a partially loaded condition shown in FIG. 1B.

In FIG. 1B a second object 18 is placed on top of the first object 17. Due to the movement of the platform (obscured), the second object 18 is loaded onto the hand truck 10 at the same height as the first object 17 was loaded when the platform (obscured) was in the unloaded condition. This means that a user is not required to bend to place objects on the hand truck 10.

Placing the second object 18 onto the hand truck 10 results in the platform (obscured) moving from the partially loaded condition illustrated in FIG. 1B to the fully loaded condition illustrated in FIG. 1C. In this Figure, a third object 19 may now be placed on top of the second object 18, with the third object 19 being loaded onto the hand truck 10 at the same height as the first object 17 in FIG. 1A and the second object 18 in FIG. 1B.

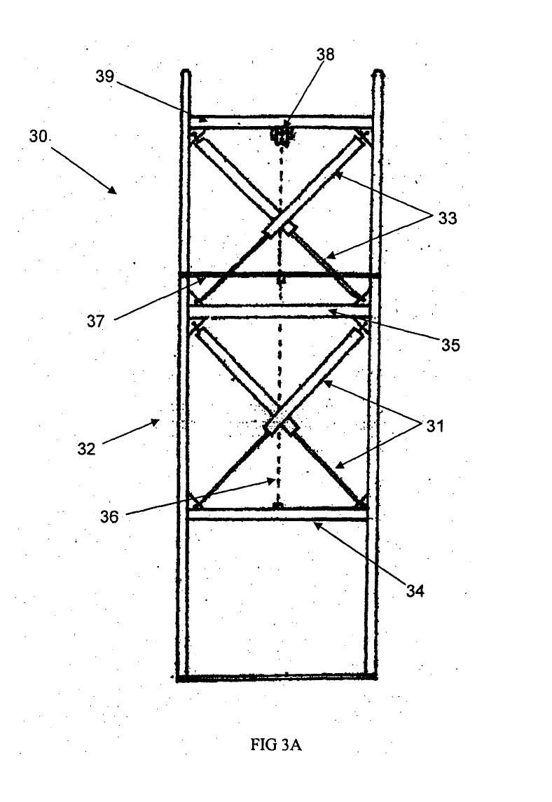

In FIGS. 2A-2C there is shown a transmission assembly 20 according to an embodiment of the present invention. The transmission assembly 20 includes a first gas strut 21 and a second gas strut 22 positioned vertically.

In FIG. 2A the transmission assembly 20 is shown in the unloaded condition. In this condition, the gas struts 21, 22 are both fully extended. The first gas strut 21 is attached at its lower end to a transmission support in the form of a platform 23. A transmission member 24 in the form of a cable is also attached to the platform 23. The cable 24 is connected at its other end to the support means (not shown).

When a first object or objects (not shown) of sufficient weight is placed on the support means (not shown), the resistance of the first gas strut 21 is overcome, and the first gas strut 21 retracts, thereby moving the transmission assembly 20 between the unloaded condition shown in FIG. 2A and the partially loaded condition shown in FIG. 2B. This movement results in a corresponding downward movement of the support means (not shown).

In the partially loaded condition a stopper 25 at the lower end of the second gas strut 22 comes into contact with a rest 26 on the platform 23. Thus, in the partially loaded condition shown in FIG. 2B, the weight of objects (not shown) placed on the support means (not shown) must be sufficient to overcome the resistance of both the first gas strut 21 and the second gas strut 22 before the platform 23 will move between the partially loaded condition and the fully loaded condition (shown in FIG. 2C). Typically, this will require the placement of additional objects onto the support means (not shown).

When the weight of objects on the support means (not shown) is sufficiently high, the resistance of both the first gas strut 21 and the second gas strut 22 will be overcome and the first and second gas struts 21, 22 retract, thereby moving the transmission assembly 20 between the partially loaded condition shown in FIG. 2B and the fully loaded condition shown in FIG. 2C. This movement results in a corresponding downward movement of the support means (not shown).

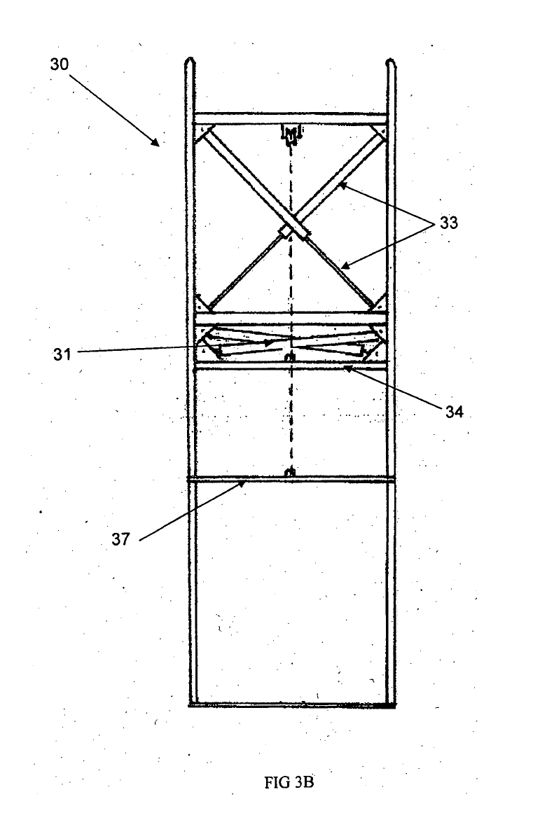

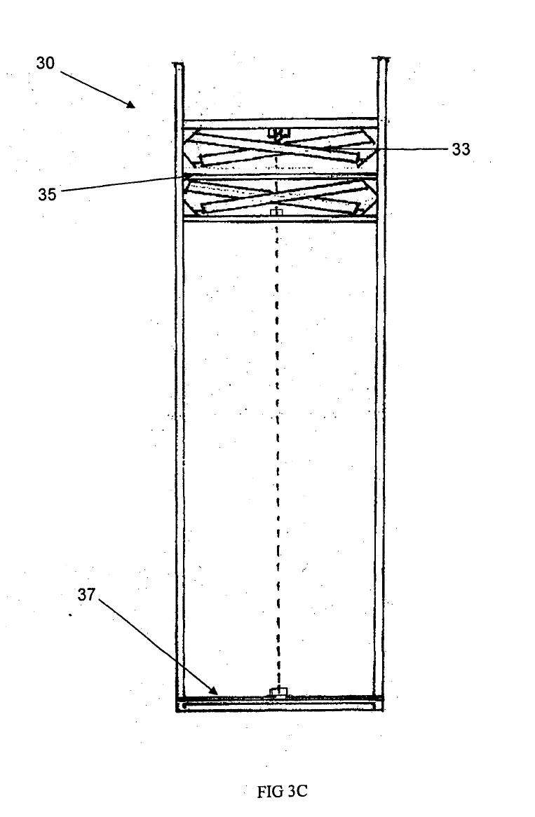

In FIG. 3A there is shown a hand truck 30 according to an embodiment of the present invention. The hand truck comprises a first pair of gas struts 31 positioned at a point in the frame 32 below a second pair of gas struts 33. The first pair of gas struts 31 is connected at its lower end to a first module platform 34, while the second pair of gas struts 33 is connected at its lower end to a second module platform 35.

A cable 36 is connected at a first end to the first module platform 34 and at a second end to the support means 37. The cable 36 is passed over a pulley 38 fixed to a horizontal frame member 39 located in an upper portion of the frame 32.

In this Figure the hand truck 30 is shown in its unloaded condition, meaning that the gas struts 31, 33 are fully extended and no or negligible weight has been placed on the support means 37. When sufficient weight is placed on the support means 37 to overcome the resistance of the first pair of gas struts 31, the support means 37 moves from the unloaded condition illustrated in FIG. 3A to the partially loaded condition illustrated in FIG. 3B.

In FIG. 3B the weight placed on the support means 37 has been sufficient to overcome the resistance of the first pair of gas struts 31 which are illustrated in their fully retracted state due to the upward movement of the first module platform 34 caused by a corresponding downward movement of the support means 37.

The second pair of gas struts 33 remain in their fully extended condition and will remain that way until such time as the first pair of gas struts 31 are fully retracted.

When sufficient additional weight is placed on the support means 37 to overcome the resistance of the second pair of gas struts 33, the support means 37 moves from the partially loaded condition illustrated in FIG. 3B to the fully loaded condition illustrated in FIG. 3C.

In FIG. 3C the weight placed on the support means 37 has been sufficient to overcome the resistance of the second pair of gas struts 33 which are illustrated in their fully retracted state due to the upward movement of the second module platform 35 caused by a corresponding downward movement of the support means 37. In the fully loaded condition, the support means 37 has reached the lower limit of its travel.

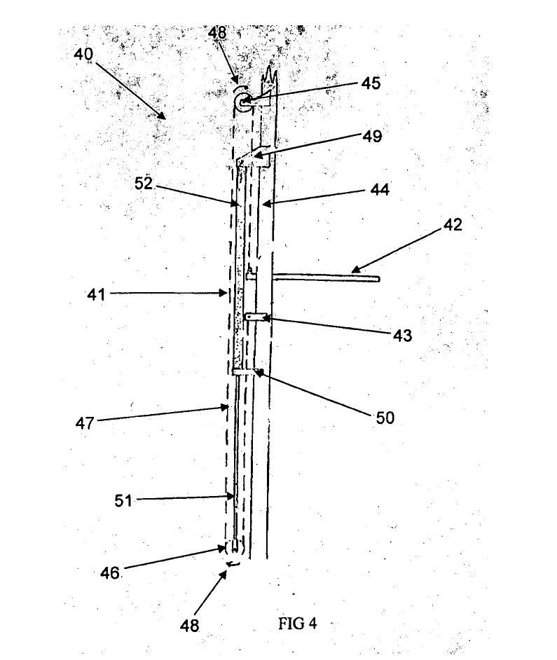

In FIG. 4, a side sectional view of a hand truck 40 according to a still further embodiment of the invention is illustrated.

In this Figure, a first end of the cable 41 is fixed to the support means 42, while a second end of the cable 41 is connected to a fixed support 43 mounted to the frame 44. The cable 41 is passed around a first pulley 45 fixed to an upper portion of the frame 44 and a second pulley 46 attached to a lower end of a gas strut 47.

When objects are placed on the support means 42, the weight of the objects overcomes some of the resistance of the gas strut 47. However, as the second end of the cable 41 is attached to a fixed support 43, a downward movement of the support means 42 results in an upward movement of the second pulley 46 as the gas strut 47 retracts.

As the support means 42 moves downwardly, the pulleys 45, 46 rotate in the direction indicated by arrows 48 due to the movement of the cable 41 over the pulleys 45, 46.

The gas strut 47 is mounted to the frame 44 via an upper mounting bracket 49 and a lower mounting bracket 50. The downward limit of the travel of the support means 42 is set by the retraction of the gas strut 47. Specifically, downward travel of the support means 42 will stop when the gas spring shaft 51 is fully retracted into the gas spring housing 52.

Those skilled in the art will appreciate that the present invention may be susceptible to variations and modifications other than those specifically described. It will be understood that the present invention encompasses all such variations and modifications that fall within its spirit and scope.

1. A transportation device comprising a frame, support means for supporting one or more objects placed thereon, the support means being movable relative to the frame, the transportation device further comprising a transmission assembly located in an upper region of the frame and associated with the support means and adapted to control movement of the support means, wherein the support means is arranged such that, in an unloaded condition, the support means is positioned towards an upper end of the frame, and whereupon placing an item or load on the support means causes the support means to move to a lower position, and wherein movement of the support means to the lower position results in the compression of at least a portion of the transmission assembly.

2. A transportation device according to claim 1 wherein placing a first item or load on the support means causes the support means to move to a first lower position, and placing a further item or load on the support means causes the support means to move to a second lower position, the second lower position being located below the first lower position.

3. A transportation device according to claim 1 wherein the transmission assembly comprises one or more extendable and retractable struts.

4. A transportation assembly according to claim 3 wherein the one or more extendable and retractable struts are gas struts.

5. A transportation device according to claim 3 wherein two or more groups of extendable and retractable struts are located at different points along the height of the frame, such that the resistance of the first group of extendable and retractable struts must be overcome before the second group of extendable and retractable struts is actuated.

6. A transportation device according to claim 5 wherein more than two groups of biasing means are located at different points along the height of the frame, such that the resistance of the first group of biasing means must be overcome before the second group of biasing means is actuated, and wherein each subsequent group of biasing means is actuated only once the resistance of the previous group of biasing means is overcome.

7. A transportation device according to claim 1 wherein the transportation device further comprises one or more support guides adapted to ensure the smooth movement of the support means between positions.

8. A transportation device according to claim 1 wherein the mass of items being added to or removed from the support means alone is sufficient to actuate the movement of the support means.

9. A transportation device according to claim 1 wherein the transportation device is a hand truck.

10. A transportation device according to claim 9 wherein the support means is capable of being fixed in a particular position to allow the conversion of the transportation device to a conventional hand truck.

11. A transportation device comprising a frame, support means for supporting one or more objects placed thereon, the support means being movable relative to the frame, and a transmission assembly located in an upper region of the frame and associated with the support means such that the transmission assembly is adapted to control the movement of the support means, and wherein the transmission assembly includes at least one biasing means that is compressed by the movement of the support means to a lower position.

12. A transportation device according to claim 11 wherein the frame comprises one or more frame members.

13. A transportation device according to claim 11 wherein the support means comprises at least a platform onto which the one or more objects are placed.

14. A transportation device according to claim 11 wherein the support means is movable relative to the frame between an unloaded condition and a fully loaded condition.

15. A transportation device according to claim 14 wherein the support means is movable relative to the frame to one or more partially loaded conditions intermediate the unloaded condition and the fully loaded condition.

16. A transportation device according to claim 14 wherein the condition to which the support means moves is determined by the mass of the one or more objects placed thereon.

17. A transportation device according to claim 11 wherein the transmission assembly includes at least one biasing means.

18. A transportation device according to claim 17 wherein when the mass of the one or more objects placed on the support means overcomes the resistance provided by the at least one biasing means, thereby allowing the support means to move at least part way between the unloaded condition and the fully loaded condition.

19. A transportation device according to claim 17 wherein the at least one biasing means is a gas strut.

20. A transportation device according to claim 17 wherein two or more groups of biasing means are located at different points along the height of the frame, such that the resistance of the first group of biasing means must be overcome before the second group of biasing means is actuated.

21. A transportation device according to claim 20 wherein more than two groups of biasing means are located at different points along the height of the frame, such that the resistance of the first group of biasing means must be overcome before the second group of biasing means is actuated, and wherein each subsequent group of biasing means is actuated only once the resistance of the previous group of biasing means is overcome.

22. A transportation device according to claim 17 wherein the transportation device further comprises transmission members connected to the support means at a first end thereof, and connected to the at least one biasing means at a second end thereof.

23. A transportation device according to claim 11 wherein the frame is provided with one or more enclosure members adapted to ensure that the transmission assembly is at least partially enclosed within the frame.

24. A transportation device according to claim 11 wherein the transportation device is a hand truck.

25. A hand truck comprising a frame, support means for supporting one or more objects placed thereon, at least one elongate transmission member located in an upper region of the frame and mounted at one end thereof to the support means and at least one biasing means, wherein the addition or removal of a load to the support means results in the movement of the support means relative to the frame, and wherein the degree of movement of the support means is controlled by the at least one biasing means.
